(19) United States
(12) Patent Application Publication
(10) Pub. No.: US 2022/0308226 A1
(43) Pub. Date: Sep. 29, 2022

(54) APPARATUS FOR SURVEYING AN ENVIRONMENT

(71) Applicant: RIEGL LASER MEASUREMENT SYSTEMS GMBH, Horn (AT)

(72) Inventor: Peter RIEGER, Grossau (AT)

(73) Assignee: RIEGL LASER MEASUREMENT SYSTEMS GMBH, Horn (AT)

(21) Appl. No.: 17/704,070

(22) Filed: Mar. 25, 2022

(30) Foreign Application Priority Data
Mar. 25, 2021 (EP) 21 164 899.3

(51) Int. Cl. G01S 17/89; G01S 7/4865; G01S 7/481

(52) U.S. Cl. CPC G01S 17/89; G01S 7/4865; G01S 7/4817

(57) ABSTRACT

An apparatus for surveying an environment comprises a first and at least one further scanning unit each for transmitting a laser beam over a series of deflection periods with a respective deflection period duration, which laser beam in each deflection period scans over a scanning fan and scans the environment along a scan line, wherein the scan lines of each scanning unit form a scan line group, and for receiving the associated laser beam reflected from the environment. The apparatus further comprises a control device connected to the at least one further scanning unit and configured to offset the scan line group of each further scanning unit with respect to the scan line group of an adjacent scanning unit in the direction of movement by a position offset which is dependent on the relative speed and the deflection period duration, in such a way that their sampling points coincide.

### CROSS-REFERENCE TO RELATED APPLICATIONS

This application claims priority to the European Patent Application No. 21 164 899.3 filed Mar. 25, 2021, the disclosure of which is incorporated herein by reference.

### TECHNICAL FIELD

The present disclosed subject matter relates to an apparatus for surveying an environment that can be moved relative to the apparatus in a direction of movement at a relative speed, by time-of-flight measurement of laser beams reflected from the environment in a coordinate system, the apparatus comprising a first scanning unit for transmitting a first laser beam over a first series of deflection periods with a respective deflection period duration, the first laser beam, in each deflection period, scanning over a first scanning fan and scanning the environment along a first scan line which is non-parallel to the direction of movement, wherein the first scan lines form a first scan line group, and for receiving the respective laser beam reflected from the environment.

### BACKGROUND

Apparatuses of this type are described, for example, in EP 3 182 159 B1 and are carried by an aircraft or ship, for example, in order to topographically survey environments such as the ground or the seabed. It is also possible to mount such an apparatus on a land vehicle, for example to survey house façades, urban canyons or tunnels as vehicle travels past them. The apparatus can also be erected in a stationary manner, for example above a conveyor belt in order to survey objects moved thereon, etc.

The scanning unit transmits a laser beam, for example pulsed or modulated, per deflection period of the series under different transmission angles within the scanning fan to many target points (“sampling points”) of the scan line in the environment, and on the basis of time-of-flight measurements of the target reflections, the target distances are determined and on this basis - knowing the arrangement of the scanning unit and the respective transmission angle—a point model (“3D point cloud”) of the environment is created. In the case of mobile, vehicle-based apparatuses, the scanning fan, which is spanned by the laser beam, is guided over the environment by the movement of the vehicle, in order to scan the environment scan line by scan line. In the case of stationary apparatuses, the environment to be surveyed is moved relative to the scanning fan, for example for surveying objects on conveyor belts.

It is desirable to create the 3D point cloud as quickly as possible and with a high spatial resolution. However, there are limits to the resolution of the point cloud. On the one hand, for example, on account of the mass inertia of a deflection mechanism of the scanning unit, the deflection period duration cannot be shortened arbitrarily, and therefore, at given relative speed, the distance between two scan lines arranged successively in the scan line group, or rather the “increment”, is subject to limits. On the other hand, with a shorter deflection period duration with constant pulse repetition rate of the laser pulses, fewer sampling points fall in a deflection period, which reduces the resolution within a scan line and thus the resolution of the 3D point cloud: With a high pulse repetition rate or greater target distance, for example, the next laser pulse is already transmitted before the reflected first transmission pulse is received, and therefore the incoming reception pulses can no longer be clearly assigned to their respective transmission pulse. This is known as the “multiple time around” (MTA) problem. The maximum size dₘₐₓ of a clearly surveyable distance range, a so-called MTA zone, results from the pulse repetition rate (PRR) and the speed of light c at dₘₐₓ=c/(2·PRR).

In addition, so-called “blind ranges” occur at the edges of each MTA zone due to the design, because the receiving electronics are saturated or overloaded by near reflections of a transmitted laser pulse on, for example, housing or mounting parts of the apparatus and are thus “blind” to the reception of a reflected laser pulse. The largest possible MTA zones are therefore desirable in order to minimise the number of “blind ranges” over the entire distance range to be surveyed. However, this in turn limits the pulse repetition rate and consequently the number of sampling points and thus the resolution of the 3D point cloud.

A mere increase in the number of sampling points in the 3D point cloud, however, does not necessarily increase its spatial resolution. For example, some target points may be sampled several times, i.e. local clusters of sampling points may form, and other areas of the environment may contain too few sampling points, so that the desired resolution of the 3D point cloud is not available over the entire environment. It is therefore essential to distribute the sampling points as evenly as possible over the environment in order to achieve a high-quality 3D point cloud.

### BRIEF SUMMARY

The objective of the disclosed subject matter is to create an apparatus for laser scanning which enables a particularly rapid and powerful creation of a 3D point cloud of the environment.

This objective is achieved with an apparatus for surveying an environment that can be move relative to the apparatus in a direction of movement at a relative speed, by time-of-flight measurement of laser beams reflected from the environment in a coordinate system, comprising

a first scanning unit for transmitting a first laser beam over a first series of deflection periods with a respective deflection period duration, the first laser beam, in each deflection period, scanning over a first scanning fan and scanning the environment along a first scan line which is non-parallel to the direction of movement, wherein the first scan lines form a first scan line group, and for receiving the respective laser beam reflected from the environment, and

at least one further scanning unit for transmitting a further laser beam over a further series of deflection periods with the same respective deflection period duration, the further laser beam, in each deflection period, scanning over a further scanning fan and scanning the environment along a further scan line non-parallel to the direction of movement, wherein the further scan lines form a further scan line group, and for receiving the respective laser beam reflected from the environment,

wherein all scanning fans, seen in the direction of movement, substantially overlap and the grouping directions of all scan line groups are substantially parallel as seen from the apparatus, and

wherein a control device is connected to the at least one further scanning unit and configured to offset the further scan line group of each further scanning unit with respect to the scan line group of a scanning unit, that is arranged adjacently in a predetermined sequence of the first and the at least one further scanning units, in the direction of movement by a position offset which is dependent on the relative speed and the deflection period duration.

The laser scanning apparatus of the disclosed subject matter can transmit two or more scanning fans simultaneously due to its plurality of scanning units, whereby at least twice as many sampling points of the environment can be created for the point cloud in the same time. Due to the relative movement between apparatus and environment, in the overlap area of the scanning fans an area of the environment already scanned by a scanning fan leading in the direction of movement can be swept and scanned again by a scanning fan trailing in this direction of movement.

The term “grouping direction” is understood to mean a direction normal to all scan lines of the respective scan line group, as seen from the apparatus. Parallel grouping directions of all scanning units as seen from the apparatus lead to parallel scan lines of different scan line groups as seen from the apparatus. The offset according to the disclosed subject matter of parallel scan line groups in the direction of movement prevents the laser beam of the trailing scanning fan from possibly hitting the sampling points of the area already scanned by the leading scanning fan again, i.e. prevents the scan lines of the leading and trailing scanning fans from coinciding. This guarantees that the environment is actually surveyed with a higher resolution.

The relative speed and deflection period duration can be fixedly predetermined for a specific surveying task or can change during the surveying process. The dependence according to the disclosed subject matter of the position offset on the relative speed and the deflection period duration of the control device enables an operation that is adapted thereto automatically. The control device can measure these values itself, for example, or can receive them from a measuring unit or an actuator with which the measurement technician sets these values during operation.

Last but not least, each scanning unit only receives its own laser beam reflected by the environment, whereby the laser beams transmitted by different scanning units are geometrically separated at the receiver. This allows, for example, the number of laser pulses processed per time unit to be multiplied according to the number of scanning units without reducing the size of the MTA zones.

As a result, the apparatus of the disclosed subject matter achieves a particularly fast, high-quality and meaningful surveying of the environment.

As briefly discussed already above, an application of the apparatus of the disclosed subject matter is that it is mounted on a vehicle, e.g. on an aircraft. Large-area environments such as entire landscapes can thus be surveyed quickly and flexibly, for example from a helicopter, a drone, an airplane, etc.

In a further embodiment, the control device is configured to predetermine the deflection period duration and/or the relative speed depending on at least one past distance measurement value of the environment. This allows the scan line increment of each scanning unit and/or the sampling point distances within each scan line to be homogenised. For example, the apparatus could be mounted on an aircraft and the control device could predetermine the deflection period duration and the relative speed depending on the flight altitude in such a way that a higher flight altitude is accompanied by longer deflection periods and slower relative speed and a lower flight altitude is accompanied by shorter deflection periods and quicker relative speed, in order to achieve, as far as possible, the same sampling point distances within the scanning fans and the same scan line distances at a constant pulse repetition rate over the entire environment to be surveyed.

It is particularly advantageous if the control device is configured to offset the further scan line group of each further scanning unit with respect to the scan line group of a scanning unit that is adjacent in the predetermined sequence, in such a way that the scan lines are arranged at regular angular intervals in the direction of movement. The regular intervals of all scan lines can be present, for example in a plan view of the environment seen from the apparatus, in a predetermined tangential plane against the environment, or—in particular with use of past distance measurement values—in scanned surfaces of the environment itself. This regular arrangement of the scan lines can prevent a possible coincidence of the sampling points of different scanning fans in the environment, and thus the resolution of the 3D point cloud can be increased.

In particular, it is favourable for this purpose if the position offset between the scan line groups of each two scanning units arranged adjacently to one another in the sequence, increased by a displacement between these two scan line groups in the direction of movement caused by the relative movement without this position offset, corresponds to the distance between two successive scan lines for a scanning unit in the direction of movement, divided by the number of all scanning units.

For example, for a regular arrangement of the scan lines, the position offset between the scan line groups of each two scanning units arranged adjacently to one another in the sequence could be chosen as

$$Δ {S}_{k , k - 1} = \frac{v \cdot {T}_{AP}}{K} - [ {D}_{k , k - 1} + h \cdot [ ( tan {α}_{k} - tan {α}_{k - 1} ) ] mod ( v \cdot {T}_{AP} ) \qquad ( 1 )$$

with

K . . . number of scanning units,

ΔS_{k,k-1} . . . position offset of the k-th scan line group with respect to the (k-1)-th scan line group,

v . . . relative speed,

T_{AP} . . . deflection period duration,

D_{k,k-1} . . . distance between vertices of the k-th and (k-1)-th and (k-1)-th scanning fans along the direction of movement,

h . . . expected normal distance between apparatus and environment,

αₖ . . . angle between an expected normal on the environment and the k-th scanning fan in a plane spanned by the direction of movement and the expected normal, and

mod . . . modulo operator.

In a further embodiment all scanning fans are substantially parallel. This makes it particularly easy to determine the position offset required to homogenise the scan lines, irrespective of the environment topography. In addition, the use of parallel scanning fans allows a maximisation of the overlap area of the scanning fans and thus of the width of the scan strip in which the environment can be scanned at the improved resolution. For example, it is thus possible to dispense with a determination of the above-mentioned tangential plane against the environment and hardware or software elements performing this determination.

In particular, in the case of substantially parallel scanning fans, the position offset between the scan line groups of each two scanning units arranged adjacently to one another in the sequence can be chosen as

$$Δ {S}_{k , k - 1} = \frac{v \cdot {T}_{AP}}{K} - {D}_{k , k - 1} mod ( v \cdot {T}_{AP} ) \qquad ( 2 )$$

with

K . . . number of scanning units,

ΔS_{k,k-1} . . . position offset of the k-th scan line group with respect to the (k-1)-th scan line group,

v . . . relative speed,

T_{AP} . . . deflection period duration,

D_{k,k-1} . . . distance between the k-th and (k-1)-th scanning fans along the direction of movement, and

mod . . . modulo operator.

As can be seen from equation (2), with the deflection period duration, the relative speed and the number of scanning fans or scanning units only values independent of the environment are included in the determination of the position offset, which significantly simplifies the complexity of the determination of the position offset.

In a further embodiment, the position offset of the scan line group(s) is achieved optically by the control device being configured to offset the scan line group of said at least one further scanning unit by controlling optical elements in the beam path of its laser beam. The use of controlled optical elements, for example electro-optical elements, pivotable or rotatable mirrors, prisms, etc., in the beam path allows the associated scanning fans to be displaced and/or pivoted in the direction of movement in order to offset the associated scan line group.

In this embodiment a temporal displacement relative to one another of the deflection periods of different scanning units can occur by the control device being configured to offset the scan line group of said at least one further scanning unit by controlling a time offset of the respective series. Oscillating or rotating mirrors of the scanning unit provided anyway can thus be actuated in a time-staggered manner, for example by delay elements, or can be phase-offset by actuators and thus can be used at the same time both to generate and to offset the scan lines.

The scanning units of the apparatus, for laser beam deflection, can be constructed, for example, with oscillating mirrors, rotating mirrors, Palmer scanners or the like. In a further apparatus design, each scanning unit comprises a deflection device with a mirror prism rotatable about its prism axis, the lateral sides of which prism each form a mirror face, and a laser transmitter for transmitting the respective laser beam in a respective transmission direction to the deflection device. With such a rotating mirror prism, a constant angular velocity profile can be achieved within each deflection period when scanning the scanning fan, with a jump back to the beginning of the scanning fan in the next deflection period, i.e. a line-by-line scanning of the environment at high speed and constant transmission angle distances within a scan line. If the deflection devices of all scanning units are optionally formed by one and the same deflection device, this results in a particularly compact design of the scanning units, and separate drives for each mirror prism can be omitted. In addition, the transmission directions of different laser transmitters can be easily coordinated by referencing them to the one common mirror prism. Furthermore, as a result of the design, a single mirror prism leads to the same deflection period duration for all scanning units, so that they do not have to be synchronised separately.

In the described optional apparatus design of the disclosed subject matter, three advantageous variants in particular—which are optionally also combinable with each other—can be provided for the offsetting of the scan lines.

In a first variant, the laser transmitter has an adjustable deflection mirror lying in the beam path of the laser beam, and the control device is configured to offset the further scan line group of said at least one further scanning unit by adjusting the associated deflection mirror. The arrangement of the deflection mirror defines the respective transmission direction and can be adjusted, for example, by an actuator connected to the control device. A lightweight deflection mirror can be adjusted, for example pivoted or displaced, particularly quickly due to its low mass inertia, so that a change to the position offset required, for example due to a change in the deflection period duration or the relative speed, can be carried out quickly. In addition, a deflection mirror can be adjusted over a large angular range and can thus also effect large changes in the transmission direction and the position offset.

In a second variant, the laser transmitter is arranged adjustably relative to the deflection device, and the control device is configured to offset the further scan line group of said at least one further scanning unit by adjusting the arrangement of the associated laser transmitter. In this variant, the laser transmitters are adjusted, for example pivoted or displaced, by actuators connected to the control device, so that large position offsets can be achieved even without deflection mirrors.

In the first and the second variant, the reception aperture of the laser receiver of each further scanning unit could be enlarged for receiving the laser pulses of pivoted or displaced scanning fans, in such a way that the reflected laser pulses of the pivoted or displaced associated scanning fan still lie within this reception aperture. Alternatively, the laser receivers of the other scanning units can retain their reception aperture if the viewing direction of the laser receivers is also pivoted or displaced along with the associated scanning fan, for example by the control device having adjustable optical elements in the beam path of the reflected laser pulses or controlling the arrangement of the laser receivers themselves.

In a third variant, the control device is configured to offset the further scan line group of said at least one further scanning unit by controlling the phase shift of the rotational movement of the associated mirror prism. In this way, the mirror prisms that are present anyway can—for example by appropriately controlling their rotation axis drives—be used at the same time for offsetting the scan lines, and there is no need for additional optical elements.

In particular in the third variant, in the case of substantially parallel scanning fans, the regular arrangement of the scan lines of all scanning units can be achieved by choosing the phase shift between the rotational movements of the mirror prisms of each two scanning units arranged adjacently to one another in the sequence as

$${Δφ}_{k , k - 1} = \frac{360 °}{K \cdot J} - {D}_{k , k - 1} \cdot \frac{360 °}{J \cdot v \cdot {T}_{AP}} \qquad ( 3 )$$

with

K . . . number of scanning units,

J . . . number of mirror faces

Δφ_{k,k-1} . . . phase shift of the mirror prism of the k-th scanning unit with respect to the mirror prism of the (k-1)-th scanning unit,

v . . . relative speed,

T_{AP} . . . deflection period duration,

D_{k,k-1} . . . distance between the k-th and (k-1)-th scanning fans along the direction of movement, and,

mod . . . modulo operator.

As can be seen from equation (3), only the deflection speed, the number of scanning units and their mirror faces are included in the determination of the phase position, so that the position offset is independent of the topography of the environment to be surveyed.

### BRIEF DESCRIPTION OF THE DRAWINGS

The disclosed subject matter will be explained in the following with reference to the exemplary embodiments shown in the accompanying drawings, in which:

FIG. 1 shows a schematic perspective view of a laser scanning apparatus mounted on an aircraft and one of its scanning units when transmitting its scanning fan to survey an environment;

FIG. 2 shows a block diagram of a transmitting and receiving channel of the apparatus of FIG. 1 with schematically drawn beam paths;

FIGS. 3a-3c show a schematic perspective view (FIGS. 3a and 3b) and a side view (FIG. 3c) of three different embodiments of the laser scanning apparatus, each mounted on an aircraft when surveying an environment by means of three scanning units, each transmitting a scanning fan and each forming a transmitting and receiving channel of the apparatus;

FIG. 4 shows exemplary phase/time graphs of the deflection devices of the scanning units of FIGS. 3a-3c in each case for a series of deflection periods;

FIG. 5 shows a plan view of an exemplary distribution of scan line groups over a detail of the environment as was obtained with the scanning fans of FIGS. 3a-3c, but without position offsetting according to the disclosed subject matter for the phase shifts of FIG. 4;

FIG. 6 shows a plan view of an exemplary distribution of regularly arranged scan line groups over a detail of the environment as obtained with the scanning fans from FIGS. 3a-3c and the offsetting of the scan line groups according to the disclosed subject matter;

FIG. 7 shows a possible embodiment of a design of the laser scanning apparatus of FIGS. 3a-3c when executing three variants for offsetting the scan line groups, in a perspective side view with schematically drawn beam paths;

FIG. 8 shows phase/time graphs of the deflection devices of the scanning units of FIGS. 3a-3c for temporally offset series of deflection periods, which are used in a variant for offsetting the scan line groups; and

FIG. 9 shows a further embodiment of a design of the laser scanning apparatuses of FIGS. 3a-3c when executing one of the variants from FIGS. 7 and 8 in a block diagram with schematically drawn beam paths.

### DETAILED DESCRIPTION

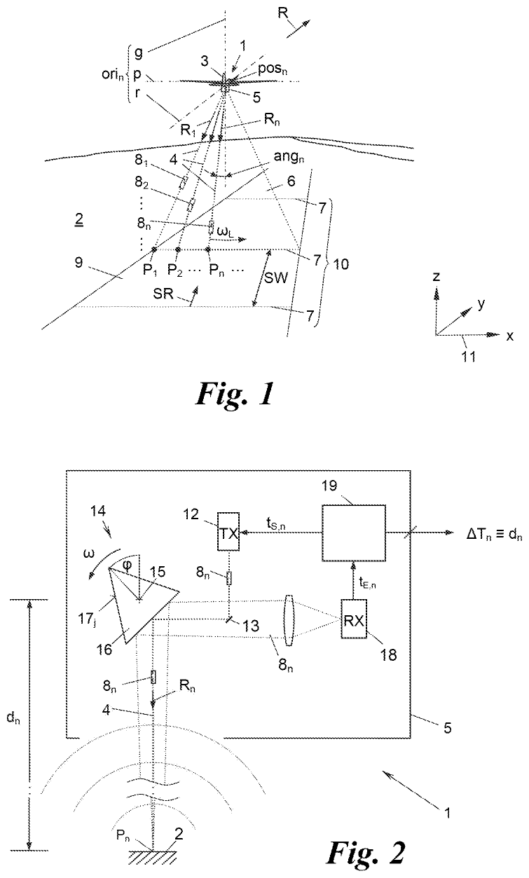

FIG. 1 shows an apparatus 1 for surveying an environment 2 from a vehicle 3. The environment 2 to be surveyed can be, for example, a landscape (terrain), but also the road surface and the façades along a stretch of road, the inner surface of a hangar, a tunnel or mine, or the sea surface or seabed, etc. The vehicle 3 can be a land, air or water vehicle, manned or unmanned. Alternatively, the apparatus 1 could also be stationary and survey an environment 2 moved relative to the apparatus 1, for example objects moving on a conveyor belt, workpieces, etc.

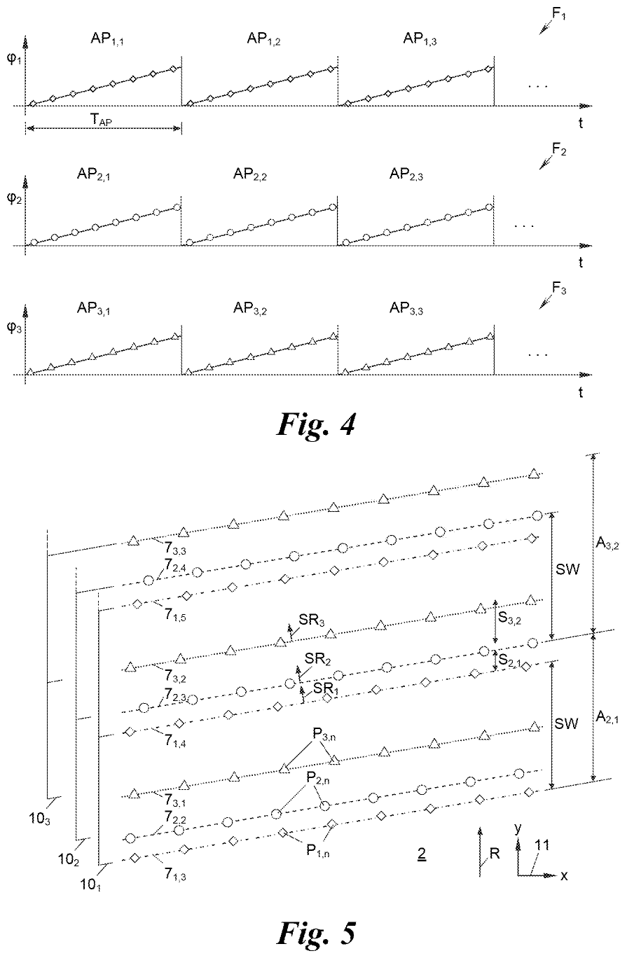

The apparatus 1 scans the environment 2 by means of a transmitted laser beam 4 for the purpose of surveying said environment. For this purpose, the laser beam 4 is pivoted back and forth by a scanning unit 5 with a deflection period AP (see later FIG. 4). As a result, the laser beam 4 within each deflection period AP scans with an angular velocity ω_{L} over a scanning fan 6, along the intersecting line 7 of which with the environment 2, i.e. the “scan line” of which, laser pulses 8ₙ (n=1, 2, . . . ) of the laser beam 4 scan the environment 2 at associated sampling points Pₙ.

In addition, the apparatus 1 is moved forward in the direction of movement R of the vehicle 3 at a relative speed v to scan the environment 2 over a series F (FIG. 4) of successive deflection periods AP with the same deflection period duration T_{AP} with a plurality of scan lines 7 in a scan strip 9. A distance SW between two successive scan lines 7, i.e. the “increment”, for a flat environment 2 parallel to the direction of movement R or in a plan view of the environment 2 is given by SW=v·TAP. The scan lines 7 of all deflection periods AP form a scan line group 10, the grouping direction SR of which is normal to each scan line 7 and tangential to the environment 2, i.e. tangential to the scanned surface (“topography”) thereof.

If the vehicle 3 is an aircraft, for example, the direction of movement R is the main direction of flight of the aircraft for which it is built. To this end, the direction of movement R is not in the plane of the scanning fan 6, i.e. the scan lines 7 are non-parallel to the direction of movement R and the grouping direction 10 is non-normal to the direction of movement R. In the case shown, the direction of movement R is normal to the plane of the scanning fan 6, so that the scanning fan 6 lies in the nadir direction of the vehicle 3 and is directed downwards towards the environment 2. However, the scanning fan 6 can also be rotated, for example about a vertical axis g of the vehicle 3, so that the scan lines 7 in the scan strip 9 lie obliquely to the projected direction of movement R. Similarly, the scanning fan 6 could be rotated about a pitch axis p and/or roll axis r of the vehicle 3.

Each laser pulse 8ₙ is transmitted by the apparatus 1 in an associated scanning direction Rₙ to the environment 2, reflected by the environment at the respective sampling point (“target point”) Pₙ of the environment 2 back to the apparatus 1 and received by the scanning unit 5. From a time-of-flight measurement of the laser pulses 8ₙ, distance measurement values dₙ from the current position posₙ of the apparatus 1 to the respective sampling point Pₙ of the environment 2 can be calculated using the known relationship

dₙ=c·ΔTₙ/2=c·(t_{E,n}-t_{S,n})/2 (4)

with

t_{S,n} . . . transmission time of the laser pulse 5ₙ,

t_{E,n} . . . reception time of the laser pulse 5ₙ and

c . . . speed of light.

Knowing the respective position posₙ of the apparatus 1 at the time of transmission of the laser pulse 8ₙ in a local or global x/y/z coordinate system 11 of the environment 2, the respective orientation oriₙ of the apparatus 1 in the coordinate system 11, indicated, for example, by the tilt, roll and yaw angles of the vehicle 3 about its transverse, longitudinal and vertical axes p, r, g, and the respective angular position angₙ of the laser pulse 8ₙ in the direction of the point Pₙ with respect to the vehicle 3, the position of the sampling point Pₙ in the coordinate system 11 can then be calculated from the respective distance measurement value dₙ. A large number of such surveyed and calculated sampling points Pₙ map the environment 2, more specifically the scanned surface thereof, in the form of a “3D point cloud” in the coordinate system 11.

FIG. 2 shows the time-of-flight measurement principle of the apparatus 1 in a transmitting/receiving channel of the apparatus 1, which is responsible for the scanning fan 6 of the scanning unit 5 shown by way of example in FIG. 1.

According to FIG. 2, the laser pulses 8ₙ are transmitted in each transmitting/receiving channel of the apparatus 1 by a laser transmitter 12 via a deflection mirror 13 and a deflection device 14. In FIG. 2 the deflection device 14 is a mirror prism 16 rotating about its prism axis 15 with an angular velocity ω, the lateral sides of which prism each form a mirror face 17ⱼ (j=1, 2, . . . , J) and about the prism axis 15 of which prism the scanning fan 6 is fanned out. The current angular position of the mirror prism 16 within a deflection period AP, i.e. the “phase” of the deflection device 14, is denoted by φ. In this case, the constant or variable angular velocity ω and the number J of mirror faces 17ⱼ give the stated deflection angular velocity ω_{L} and the deflection period duration T_{AP} according to the formulas ω_{L}=2·ω and T_{AP}=360°/(ω_{d}·J ), wherein ω_{d} denotes the average angular velocity ω_{A}. Alternatively, the deflection device 14 could be implemented by any other deflection device known in the prior art, for example an oscillating mirror, rotating mirror pyramid, etc.

The transmitted laser pulses 8ₙ are received back on the same path via the deflection device 14 after reflection at the respective environment point Pₙ and strike a laser receiver 18, i.e. the current viewing direction of the laser receiver 18 is equal to the current scanning direction Rₙ. The transmission times t_{S,n} of the laser pulses 8ₙ and the reception times t_{E,n} of the environment-reflected laser pulses 8ₙ are fed to a distance calculator 19, which calculates the respective distance dₙ therefrom using equation (4).

The pulse rate (pulse repetition rate, PRR) of the laser pulses 8ₙ is constant or can be modulated, for example for resolving MTA (multiple time around) ambiguities within a deflection period AP, in order to facilitate the assignment of transmitted and received laser pulses 8ₙ to each other, as known in the art.

Alternatively, for a time-of-flight measurement and assignment of the transmitted and received laser beam 4, the latter could also not be pulsed, for example could be modulated or continuous (“continuous wave”), as known in the prior art.

The angular velocity ω and thus the deflection period duration T_{AP} of the deflection device 14 and/or the relative speed v can optionally be coordinated with a measured or expected distance dₙ, for example in order to obtain, over an environment 2 with extremely variable topography, regular intervals of the sampling points Pₙ within each scan line 7 and a regular increment SW between successive scan lines 7.

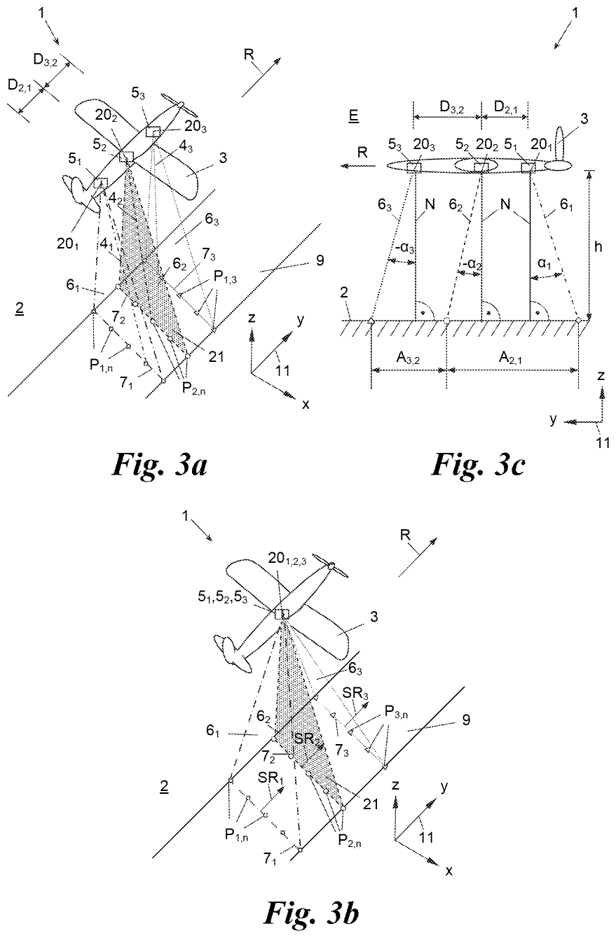

In FIGS. 1 and 2, only the scanning fan 6 of one scanning unit 5 of the apparatus 1 or the associated transmitting/receiving channel has been shown to explain the measuring principle. By contrast, FIGS. 3a-3c each show the laser scanning apparatus 1 carried on the aircraft 3 with several (here: three) scanning units 5ₖ (k=1, 2, . . . , K; here K=3) as described in conjunction with FIGS. 1 and 2, i.e. in a predetermined sequence of a “first”, “second” and “third” scanning unit 5₁, 5₂, 5₃. It is understood that the apparatus 1 can have any number K>1 of scanning units 5ₖ.

Each of the three scanning units 5ₖ repeatedly transmits its respective laser beam 4ₖ with laser pulses 8_{k,n} over a series Fₖ (FIG. 4) of deflection periods APₖ, wherein the deflection period duration T_{AP} is the same for all scanning units 5. Per deflection period APₖ, each laser beam 4ₖ fans out an associated scanning fan 6ₖ, in order to scan the environment 2 along associated scan lines 7ₖ which are non-parallel to the direction of movement R and which form a scan line group 10ₖ per scanning unit 5ₖ.

In the embodiment of FIG. 3a, the scanning fans 6ₖ are substantially parallel and their vertices 20ₖ are spaced apart in the direction of movement R with mutual distances D_{k,k-1} from each other. In the embodiment of FIG. 3b, the scanning fans 6ₖ are not parallel and their vertices 20ₖ are coincident. In the embodiment of FIG. 3c, the vertices 20ₖ of the scanning fans 6ₖ are spaced apart from one another in the direction of movement R by mutual distances D_{k,k-1}, and the scanning fans 6ₖ, in a plane E spanned by the direction of movement R and the normal N, are arranged at different angles α₁, α₂, α₃ to a normal N on the environment 2 approximated as a plane.

In each of the embodiments of FIGS. 3a-3c, the grouping directions SRₖ of the scan line groups 10ₖ are, in a plan view of the environment 2, i.e. as seen from the apparatus 1, substantially parallel to each other, and the scanning fans 6ₖ substantially overlap each other, seen in the direction of movement R, in a common overlap area 21 (hatched), in which overlap area the sampling points P_{k,n} of several scanning fans 6ₖ thus come to lie, as seen in the direction of movement R. As a result, a scanning fan 6ₖ trailing in the direction of movement R follows a scanning fan 6ₖ leading in this direction due to the relative movement between apparatus 1 and environment 2 and scans once again the part of the common scan strip 9 already surveyed by the leading scanning fan. For example the trailing scanning fan 6₁ can rescan the scan lines 7₂, 7₃ of its two leading scanning fans 6₂, 6₃, and the trailing scanning fan 6₂ can rescan the scan lines 7₃ of its leading scanning fan 6₃. Due to the substantially parallel grouping directions SRₖ, the scan lines 7ₖ of the trailing scanning fans 6ₖ, when the trailing scanning fans 6ₖ reach the scan lines 7ₖ already scanned by a leading scanning fan 6ₖ, are substantially parallel thereto.

The scanning fans 6ₖ are not necessarily flat. For example, in FIGS. 3b and 3c, the scanning fans 6₁, 6₃, which are inclined forwards or backwards in the direction of travel F, may lie on slightly curved cone envelope surfaces, for example due to the deflection mechanism of the laser pulses 8_{k,n}. This can be disregarded for the purposes of the present disclosed subject matter; the expression “substantially parallel” scanning fans, scan lines or scan line groups are thus also understood in the present disclosure to mean those which, for example, are curved slightly differently or are largely parallel only in their middle regions.

Instead of as shown in FIGS. 3a-3c, the scanning fans 6ₖ could also be in any other arrangement relative to each other, as long as they overlap each other at least in pairs in an overlap area 21 and the grouping directions SRₖ of their scan lines 7ₖ are substantially parallel.

FIGS. 4 and 5 illustrate a mutually uncoordinated deflection of the laser beams 4ₖ of the individual scanning unit 5ₖ, i.e. in each case without taking into account the other scanning units 5ₖ. For this purpose, FIG. 4 shows the phase φₖ of the deflection device 14ₖ for each scanning unit 5ₖ plotted over the time t for its respective series Fₖ of deflection periods AP_{k,p} (p=1, 2, . . . ). FIG. 5 shows the groups 10ₖ of scan lines 7_{k,p} thus generated for several deflection periods AP_{k,p}.

The deflection devices 14ₖ deflect their laser beams 4ₖ, in the example shown, synchronously with the same deflection period duration T_{AP}, the same angular velocity ω and the same phase φₖ (t), i.e. their series Fₖ of deflection periods AP_{k,p} are identical. Depending on the size of the deflection period duration T_{AP}, relative speed v and arrangement of the scanning fans 6ₖ, this results in different distributions of the scan lines 7_{k,p} over the environment 2, as shown in a simple form on the basis of a flat environment 2 in FIG. 5.

If a simultaneous spacing A_{k,k-1}, i.e. a spacing between two simultaneously surveyed scan lines 7_{k,p}, 7_{k-1,p} of different scanning fans 6ₖ, 6ₖ₋₁, is a multiple of the increment SW, i.e. A_{k,k-1}=m·SW (m . . . a natural number), the scan lines 7_{k,p}, 7_{k-1,q} (q≠p) of different scanning fans 6ₖ, 6ₖ₋₁ come to lie at the same location as considered spatially, more specifically temporally one after the other due to the relative movement in the direction R. As a result, the sampling points P_{1,n} (shown as diamonds) and P_{2,n} (shown as circles) of the trailing scanning fans 6₁, 6₂ coincide with the already scanned sampling points P_{3,n} (shown as triangles) of the leading scanning fan 6₃, i.e. the scan line groups 10ₖ coincide—apart from the start and end phases of the scanning process. As can be seen from FIG. 3c, by determining or predetermining a normal spacing h between apparatus 1 and environment 2 and the angles αₖ, αₖ₋₁ of the respective scanning fans 6ₖ, 6ₖ₋₁, the simultaneous spacing A_{k,k-1} can be determined as A_{k,k-1}=D_{k,k-1}+h·(tan(αₖ)-tan(αₖ₋₁)).

If the simultaneous spacing A_{k,k-1} is not a multiple of the increment SW, that is to say A_{k,k-1}≠m·SW (“relatively prime”), the scan lines 7ₖ, 7ₖ₋₁ of different scanning units 5ₖ, 5ₖ₋₁ do not coincide, and instead their scan line groups 10ₖ are spaced apart from one another with a mutual displacement S_{k,k-1}. This generally results in an irregular juxtaposition of the scan lines 7ₖ of all scanning units 5ₖ, as shown in FIG. 5.

FIGS. 6-9 illustrate how such coincidence or irregular juxtaposition of the scan lines 7_{k,p} of different scanning units 5ₖ can be prevented and the scan lines 7_{k,p} can be distributed more evenly over the environment 2.

For this purpose, as shown in FIG. 6, the scan line group 10₂ of the second scanning unit 5₂ is offset with respect to the scan line group 10₁ of the adjacent first scanning unit 5₁, and the scan line group 10₃ of the third scanning unit 5₃ is offset with respect to the scan line group 10₂ of the adjacent second scanning unit 5₂, in each case by a position offset ΔS_{2,1}, ΔS_{3,2} in the direction of movement R. It should be mentioned that the order of the scanning units 5ₖ is arbitrary, i.e. which of the scanning units 5ₖ is designated as “first”, “second”, “third” etc. is arbitrary. The term “adjacent” scanning unit 5ₖ is therefore not to be understood in a local sense but in a numerical sense in this arbitrarily specified sequence.

For example, in the case of three scanning units 5₁, 5₂, 5₃, the position offsets ΔS_{2,1} and ΔS_{3,2} are chosen in such a way that, added with the associated displacement S_{k,k-1} caused by the increment SW and the simultaneous spacing A_{k,k-1} being relatively prime, they correspond to a third of the increment SW, whereby the scan lines 7ₖ of all scanning fans 6ₖ, if these have passed through one and the same region of the scan strip 9, come to lie there at regular intervals Sᵣ=SW/3. In particular, the position offset ΔS_{k,k-1} of two scan line groups 10ₖ, 10ₖ₋₁, increased by the displacement S_{k,k-1} between these two scan line groups 10ₖ, 10ₖ₋₁, corresponds in each case to the increment SW between two scan lines 7_{k,p}, 7_{k,p+1} scanned successively by a scanning fan 6ₖ, divided by the number K of all scanning units 5ₖ.

If, in addition, the pulse repetition rate PRR is chosen as a function of a measured or expected distance d_{k,n} to the environment 2 and is changed within the deflection period AP_{k,p}, the sampling points P_{k,n} as shown in FIGS. 5 and 6 can also be arranged regularly within the scan line 7_{k,p}.

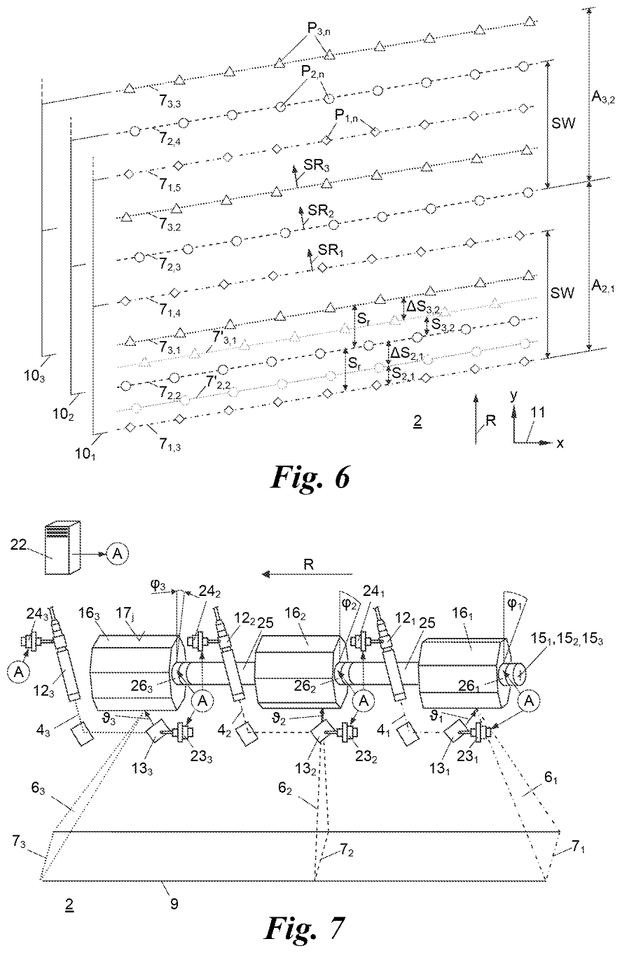

FIGS. 7-9 show three possible variants for offsetting the scan line groups 10ₖ in the manner described in FIG. 6. For each of these variants, the apparatus 1 has a control device 22, which controls the optical elements in the beam path of the associated laser beams 4ₖ, for example electro-optical elements, mirrors, prisms, etc., in order to offset the scan line groups 10ₖ.

In a first variant (FIG. 7), the control device 22 contains a controlled actuator 23ₖ for each scanning unit 5ₖ, which actuator can adjust the arrangement of its deflection mirror 13ₖ, i.e. its position and/or orientation. This displaces or tilts a respective transmission direction ϑₖ to the respective mirror prism 16ₖ and thus the associated scanning fan 6ₖ depending on the required position offset ΔS_{k,k-1}, i.e. the angle αₖ between scanning fans 6ₖ and normal N and/or the spacing D_{k,k-1} between scanning fans and vertices 20ₖ changes.

In a second variant (FIG. 7), the laser transmitters 12ₖ are adjustably mounted and the control device 22 controls actuators 24ₖ which can change the position and/or orientation, i.e. the arrangement, of the respective laser transmitter 12ₖ with respect to a common or (here:) respective mirror prism 16ₖ and thus the transmission direction ϑₖ and can adjust the position offset ΔS_{k,k-1}.

It is understood that for the time-of-flight measurement, the laser pulses 8_{k,n} of the displaced or tilted scanning fans 6ₖ must also be received by the associated laser receivers 18ₖ in the first and second variants. For this purpose, in one embodiment, these laser receivers 18ₖ have a reception aperture which is so large that the reflected laser pulses 8_{k,n} pass through it despite the displacement or tilting of the associated scanning fan 6ₖ. In an alternative embodiment, these laser receivers 18ₖ retain their, for example optimally adapted, reception aperture and the viewing directions of these laser receivers 18ₖ are also displaced or tilted along with the associated scanning fan 6ₖ, For this co-tilting or displacement, the control device 22 could - as described in the first or second variant for the transmission channel—have actuators to control adjustable optical elements in the reception channel or could control the arrangement of these laser receivers 18ₖ themselves.

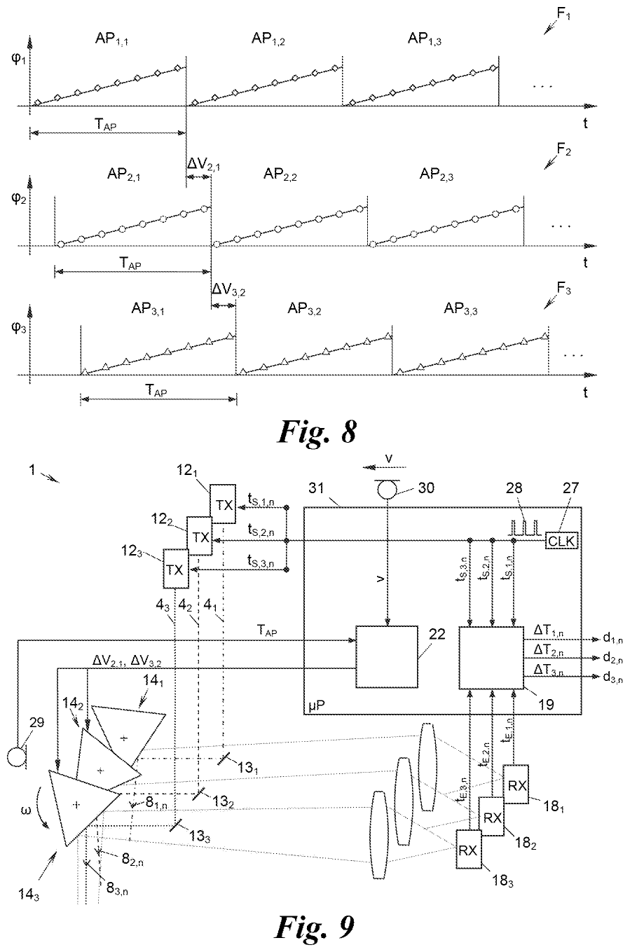

In a third variant, also shown in FIGS. 7-9, the control device 22 controls actuators 26ₖ mounted on a common drive shaft 25 of the mirror prisms 16ₖ, with which actuators the mirror prisms 16ₖ can each be individually rotated relative to the drive shaft 25 in order to set the phase shift Δφ_{k,k-1}=φₖ-φₖ₋₁ between two mirror prisms 16ₖ, 16ₖ₋₁. By setting the phase shift Δφ_{k,k-1}, there is a time offset so to speak, shown in FIG. 8, of the series Fₖ of sampling periods AP_{k,p} by a corresponding time offset ΔV_{k,k-1}=Δφ_{k,k-1}/ω.

The fact that a control of this kind of the phase shifts Δφ_{k,k-1} or of the series Fₖ also leads to a position offset ΔS_{k,k-1} of the respective scan line group 10ₖ in the direction of movement R is evident from FIG. 6: For example, a scan line 7′_{2,2}, as would be created without any offset of the phase shift Δφ_{2,1} (FIG. 5), by way of time delaying the associated deflection period AP_{2,2} by the time offset ΔV_{2,1}, during which the scanning unit 5ₖ on account of its relative movement in the direction of movement R covers the path and thus the position offset ΔS_{2,1}=v·ΔV_{2,1}, is thus actually generated as a scan line 7_{2,2} displaced by the position offset ΔS_{2,1}.

FIG. 9 shows a block diagram of an electronic implementation of this third variant in a three-channel apparatus 1 according to the exemplary embodiments from FIGS. 3a-3c. Each scanning unit 5ₖ comprises a laser transmitter 12ₖ and an associated laser receiver 18ₖ, which each cooperate via a deflection device 14ₖ—as shown in FIG. 2 for one channel—and are connected to a common distance computer 19, which calculates the respective distances d_{k,n} to the sampling points P_{k,n}. A clock generator 27 generates a control pulse train 28 for the laser transmitters 12ₖ, which generate the laser pulses 8_{k,n} therefrom. The control device 22 delays the associated deflection device 14ₖ with respect to the deflection device 14ₖ₋₁ of a scanning unit 5ₖ₋₁, that is arranged adjacently in the sequence of the scanning units 5ₖ, by the time offset ΔV_{k,k-1} and thus the associated series Fₖ of deflection periods AP_{k,p}; see FIG. 8. In order to delay the series Fₖ by the respective time offset ΔV_{k,k-1}, the control device 22, as mentioned, can control the actuators 26ₖ or alternatively can offset control signals of the deflection devices 14ₖ by the time offsets for example in the case of deflection devices that have oscillating mirrors.

In each of the described variants, the position offset ΔS_{k,k-1} to be used, the time offset ΔV_{k,k-1}, or the phase shift Δφ_{k,k-1} can be determined by the control device 22. To this end, the control device 22 for example receives the current deflection period duration T_{AP} from a first sensor 29 and the relative speed v from a second sensor 30 and determines the respective values depending thereon.

The control device 22 can be implemented jointly with the distance computer 19 in a processor system 31, more specifically in hardware and/or software.

In all described embodiments and variants, the control device 22 thus offsets the scan line groups 10ₖ in the direction of movement R, more specifically offsets the second scan line group 10₂ with respect to the first scan line group 10₁ by the position offset ΔS_{2,1}, and offsets the third scan line group 10₃ with respect to the second scan line group 10₂ by the position offset ΔS_{3,2}. For example, it could be that ΔS_{k,k-1}=ΔV_{k,k-1}·v, in order to obtain the uniform scan line groups 10ₖ as per FIG. 6 in a plan view of the environment 2.

In particular, the control device 22 can set the position offsets ΔS_{k,k-1}, the phase shifts Δφ_{k,k-1} and/or the time offsets ΔV_{k,k-1} for the embodiment of FIG. 3a and the scan line homogenisation of FIG. 6 according to one of the formulas

$$Δ {S}_{k , k - 1} = \frac{v \cdot {T}_{AP}}{K} - {D}_{k , k - 1} mod ( v \cdot {T}_{AP} ) \qquad ( 2 )$$

$$Δ {φ}_{k , k - 1} = \frac{360 °}{K \cdot J} - {D}_{k , k - 1} \cdot \frac{360 °}{J \cdot v \cdot {T}_{AP}} \qquad ( 3 )$$

$$Δ {V}_{k , k - 1} = \frac{{T}_{AP}}{K} - \frac{{D}_{k , k - 1}}{v} \qquad ( 5 )$$

$$Δ {V}_{k , k - 1} = \frac{{T}_{AP}}{K} - \frac{1}{v} [ {D}_{k , k - 1} mod ( v \cdot {T}_{AP} ) ] \qquad ( 6 )$$

with

K . . . number of scanning units 5ₖ,

J . . . number of mirror faces 17ⱼ,

ΔS_{k,k-1} . . . position offset of the k-th scan line group 10ₖ with respect to the (k−1)-th scan line group 10ₖ₋₁;

Δφ_{k,k-1} . . . phase shift of the mirror prism 16 of the k-th scanning unit 5ₖ with respect to the mirror prism 16 of the (k−1)-th scanning unit 5ₖ₋₁,

ΔV_{k,k-1} . . . time offset of the series Fₖ of the k-th scanning unit 5ₖ with respect to the series Fₖ₋₁ of the (k−1)-th scanning unit 5ₖ₋₁,

v . . . relative speed,

AP . . . deflection period duration,

D_{k,k-1} . . . distance between the k-th and (k−1)-th scanning fans 6ₖ along the direction of movement R and

mod . . . modulo operator.

Optionally, the control device 22 can determine the position offset ΔS_{k,k-1} that is to be set, the phase shifts Δφ_{k,k-1} and/or the time offsets ΔV_{k,k-1} also depending on further values, for example the angles αₖ, the normal distance h, etc.

The regular intervals Sᵣ of FIG. 6 can be achieved by the control device 22, for example for the embodiment of FIG. 3c, in accordance with

$$Δ {S}_{k , k - 1} = \frac{v \cdot {T}_{AP}}{K} - [ {D}_{k , k - 1} + h \cdot ( tan {α}_{k} - tan {α}_{k - 1} ) ] mod ( v \cdot {T}_{AP} ) \qquad ( 1 )$$

$$Δ {φ}_{k , k - 1} = \frac{360 °}{K \cdot J} - \frac{360 °}{v \cdot {T}_{A P} \cdot J} ( [ {D}_{k , k - 1} + h \cdot ( tan {α}_{k} - tan {α}_{k - 1} ) ] mod ( v \cdot {T}_{AP} ) ) \qquad ( 7 )$$

$$Δ {V}_{k , k - 1} = \frac{{T}_{AP}}{K} - \frac{1}{v} ( [ {D}_{k , k - 1} + h \cdot ( tan {α}_{k} - tan {α}_{k - 1} ) ] mod ( v \cdot {T}_{AP} ) ) \qquad ( 8 )$$

with

K . . . number of scanning units 5ₖ,

ΔS_{k,k-1} . . . position offset of the k-th scan line group 10ₖ with respect to the (k−1)-th scan line group 10ₖ₋₁;

Δφ_{k,k-1} . . . phase position of the mirror prism 16 of the k-th scanning unit 5ₖ with respect to the mirror prism 16 of the (k−1)-th scanning unit 5ₖ₋₁,

ΔV_{k,k-1} . . . time offset of the series Fₖ of the k-th scanning unit 5ₖ with respect to the series Fₖ₋₁ of the (k−1)-th scanning unit 5ₖ₋₁,

v . . . relative speed,

T_{AP} . . . deflection period duration,

D_{k,k-1} . . . distance between the vertices 20ₖ of the k-th and (k−1)-th scanning fans 6ₖ along the direction of movement R,

h . . . expected normal spacing between apparatus 1 and environment 2,

αₖ . . . angle between the expected normal N on the environment 2 and the k-th scanning fans 6ₖ in the plane E spanned by the direction of movement R and the expected normal N, and

mod . . . modulo operator.

To this end, the normal N, the normal spacing h and the angles αₖ, αₖ₋₁ can be estimated or anticipated, for example determined from past sampling points P_{k,n} and the position of the apparatus 1. In a non-flat environment 2, a plan view of the environment 2 can be used for this purpose, or the environment 2 can be approximated, for example by a plane, in particular a tangential plane at its surface (topography).

Of course, in further variants there may also be other optical elements upstream or downstream of the deflection device 14 in the beam path of the laser beam 4ₖ, and these optical elements can be controlled by the control device 22 to offset the scan line groups 10ₖ.

It is understood that the described embodiments and variants can be used both individually and in any combinations. The disclosed subject matter is not limited to the embodiments presented, but encompasses all variants, modifications and combinations thereof which fall within the scope of the appended claims.

What is claimed is:

1. An apparatus for surveying an environment that can be moved relative to the apparatus in a direction of movement at a relative speed, by time-of-flight measurement of laser beams reflected from the environment in a coordinate system, comprising
a first scanning unit for transmitting a first laser beam over a first series of deflection periods with a respective deflection period duration, the first laser beam, in each deflection period, scanning over a first scanning fan and scanning the environment along a first scan line which is non-parallel to the direction of movement, wherein the first scan lines form a first scan line group, and for receiving the respective laser beam reflected from the environment, and
at least one further scanning unit for transmitting a further laser beam over a further series of deflection periods with the same respective deflection period duration, the further laser beam, in each deflection period, scanning over a further scanning fan and scanning the environment along a further scan line non-parallel to the direction of movement, wherein the further scan lines form a further scan line group, and for receiving the respective laser beam reflected from the environment,
wherein all scanning fans, seen in the direction of movement, substantially overlap and grouping directions of all scan line groups are substantially parallel as seen from the apparatus, and
wherein a control device is connected to the at least one further scanning unit and configured to offset the further scan line group of each further scanning unit with respect to the scan line group of a scanning unit, that is arranged adjacently in a predetermined sequence of the first and the at least one further scanning units, in the direction of movement by a position offset which is dependent on the relative speed and the deflection period duration.

2. The apparatus according to claim 1, wherein it is mounted on a vehicle or on an aircraft.

3. The apparatus according to claim 1, wherein the control device is configured to predetermine the deflection period duration and/or the relative speed depending on at least one past distance measurement value of the environment.

4. The apparatus according to claim 1, wherein the control device is configured to offset the further scan line group of each further scanning unit with respect to the scan line group of a scanning unit that is adjacent in the predetermined sequence, in such a way that the scan lines are arranged at regular intervals in the direction of movement.

5. The apparatus according to claim 1, wherein the position offset between the scan line groups of each two scanning units arranged adjacently to one another in the sequence, increased by a displacement between these two scan line groups in the direction of movement caused by the relative movement without this position offset, corresponds to the distance between two successive scan lines of a scanning unit in the direction of movement, divided by the number of all scanning units.

6. The apparatus according to claim 1, wherein the position offset between the scan line groups of each two scanning units arranged adjacently to one another in the sequence is chosen as
$$Δ {S}_{k , k - 1} = \frac{v \cdot {T}_{AP}}{K} - [ {D}_{k , k - 1} + h \cdot ( tan {α}_{k} - tan {α}_{k - 1} ) ] mod ( v \cdot {T}_{A P} )$$
with
K . . . number of scanning units,
ΔS_{k,k-1} . . . position offset of the k-th scan line group with respect to the (k−1)-th scan line group,
v . . . relative speed,
T_{AP} . . . deflection period duration,
D_{k,k-1} . . . distance between vertices of the k-th and (k−1)-th scanning fans along the direction of movement,
h . . . expected normal distance between apparatus and environment,
αₖ . . . angle between an expected normal on the environment and the k-th scanning fan in a plane spanned by the direction of movement and the expected normal, and
mod . . . modulo operator.

7. The apparatus according to claim 1, wherein all scanning fans are substantially parallel.

8. The apparatus according to claim 7, wherein the position offset between the scan line groups of each two scanning units arranged adjacently to one another in the sequence is chosen as
$$Δ {S}_{k , k - 1} = \frac{v \cdot {T}_{AP}}{K} - {D}_{k , k - 1} mod ( v \cdot {T}_{AP} )$$
with
K . . . number of scanning units,
ΔS_{k,k-1} . . . position offset of the k-th scan line group with respect to the (k−1)-th scan line group,
v . . . relative speed,
T_{AP} . . . deflection period duration,
D_{k,k-1} . . . distance between the k-th and (k−1)-th scanning fans along the direction of movement, and
mod . . . modulo operator.

9. The apparatus according to claim 1, wherein the control device is configured to offset the scan line group of said at least one further scanning unit by controlling optical elements in the beam path of its laser beam.

10. The apparatus according to claim 9, wherein the control device is configured to offset the scan line group of said at least one further scanning unit by controlling a time offset of the respective series.

11. The apparatus according to claim 1, wherein each scanning unit comprises:
a deflection device with a mirror prism rotatable about a prism axis, lateral sides of which mirror prism each form a mirror face, and
a laser transmitter for transmitting the respective laser beam in a respective transmission direction to the deflection device.

12. The apparatus according to claim 11, wherein the laser transmitter further comprises an adjustable deflection mirror lying in the beam path of the laser beam, and the control device is configured to offset the further scan line group of said at least one further scanning unit by adjusting the associated deflection mirror.

13. The apparatus according to claim 11, wherein the laser transmitter is arranged adjustably relative to the deflection device, and the control device is configured to offset the further scan line group of said at least one further scanning unit by adjusting the arrangement of the associated laser transmitter.

14. The apparatus according to claim 11, wherein the control device is configured to offset the further scan line group of said at least one further scanning unit by controlling the phase shift of the rotational movement of the associated mirror prism.

15. The apparatus according to claim 14, wherein all scanning fans are substantially parallel and wherein the phase shift between the rotational movements of the mirror prisms of each two scanning units arranged adjacently to one another in the sequence is chosen as
$$Δ {φ}_{k , k = 1} = \frac{360 °}{K \cdot J} - {D}_{k , k - 1} \cdot \frac{360 °}{J \cdot v \cdot {T}_{AP}}$$
with
K . . . number of scanning units,
J . . . number of mirror faces,
Δφ_{k,k-1} . . . phase shift of the mirror prism of the k-th scanning unit with respect to the mirror prism of the (k−1)-th scanning unit,
v . . . relative speed,
T_{AP} . . . deflection period duration, distance between the k-th and (k−1)-th scanning fans along the direction of movement, and
mod . . . modulo operator.
